(19) United States
(12) Patent Application Publication
(10) Pub. No.: US 2020/0068360 A1
(43) Pub. Date: Feb. 27, 2020

(54) SYSTEM AND METHOD FOR SENDING MMS MESSAGES

(71) Applicant: KYUNG HWI NHO, FAIRVIEW, NJ (US)

(72) Inventor: KYUNG HWI NHO, FAIRVIEW, NJ (US)

(21) Appl. No.: 16/109,921

(22) Filed: Aug. 23, 2018

(51) Int. Cl. H04W 4/12; H04L 29/12; H04W 4/24; H04L 12/14

(52) U.S. Cl. CPC H04W 4/12; H04L 61/301; H04L 61/307; H04L 12/1403; H04L 61/605; H04W 4/24

(57) ABSTRACT

The present invention is a system and method for sending MMS messages that includes a hardware device, a first server, and a second server, retrieves a particular routing syntax by looking up of a corresponding servicing carrier linked to a phone number, converts the phone number and the particular routing syntax into a text email address, and forwards MMS messages to the appropriate mobile device linked to the phone number and the particular routing syntax using the text email address.

### TECHNICAL FIELD & BACKGROUND

The present invention generally related to a system and method for sending MMS messages.

Multimedia Messaging Service (MMS) is a standard way to send messages that include multimedia content to and from a mobile phone over a cellular network. Users and providers may refer to such a message as a picture message or a multimedia message. The MMS standard extends the core SMS (Short Message Service) capability, allowing the exchange of text messages greater than 160 characters in length. Unlike text-only SMS, MMS can deliver a variety of media, including up to forty seconds of video, one image, a slideshow of multiple images, or audio.

The most common use involves sending photographs from mobile devices. Media companies have utilized MMS on a commercial basis as a method of delivering news and entertainment content, and retailers have deployed it as a tool for delivering scannable coupon codes, product images, videos, and other information.

Most carriers in other parts of the world enjoy common technologies with adjacent carriers. For instance, most carriers in Europe have a wireless network conforming to the GSM standards. Accordingly, interconnection between different carriers is simple and straight forward because they all use the same air interface (i.e., GSM). Thus, MMS Inter-Carrier messaging may be accomplished through direct carrier-to-carrier interconnections. Accordingly, there is no technical barrier to interconnectivity between different carrier networks. Thus a user in Europe can directly send mobile device MMS messages from his hardware device only with the recipient's phone number.

On the other hand, the interconnection of like air interface technologies (such as GSM) is not generally an option in the US. In the US, each major US carrier has deployed a different, competing air interface technology (e.g., CDMA, UMTS, and GSM). There are approximately ten (10) different air interface technology protocols currently in use in the United States. While this technology dispersion allows carriers to differentiate their service offers from one another, the US consumer suffers inconvenience because of the lack of standardization and/or interoperability across networks.

For those reasons, email and web-based gateways to the MIMS system are common in the U.S. For sending from external sources to mobile devices, most carriers allow a MMS message to be sent to the receiver's phone number using a special e-mail address combining the recipient's public phone number and a special domain name, which is typically carrier-specific.

With current systems in the U.S., MMS messaging (i.e., between different carrier networks) from a hardware device to a mobile device requires input of a complete e-mail address. In particular, for a user of a hardware device to send a MMS message to a user of a mobile device, the user of the hardware device must know and input a full e-mail address of the destination device such as the exact format address syntax of a phone number on the recipient's network (e.g., “@mobile.att.net”). Exemplary full e-mail addresses typically comprise a phone number, the “@” sign, and then a unique domain name used specifically for MMS messaging. An exemplary full e-mail address is 4105551234@mobile.myportal.xyzwireless.net.

Practically speaking, most people remember or note down the mobile phone number of desired people to call. However, most people have no knowledge of the exact carrier with which those desired people to call are serviced by. Without remembering the identity of the person's carrier, a user has great difficulty in determining a full e-mail address for that person. Without changing US society to remember not only phone numbers of others but also which carrier each of the others are with, MMS messaging from a hardware device to a mobile device will find adoption to be slow.

Thus, there is a need for a system and method that allows users in the United States to send a mobile device MMS messages using a hardware device without having to look-up the identity of the recipient's carrier and/or email address associated with the mobile device.

### SUMMARY OF THE INVENTION

The present invention is directed to a system and method for sending MMS messages that overcomes the above mentioned disadvantages of the prior art. In one aspect, the present invention provides a system for sending MMS messages comprises a hardware device, a first sever device, and a second server device. The hardware device receives and forwards a MMS message, a phone number and a particular routing syntax linked to the phone number via the Internet. The first server device receives the phone number from the hardware device via the Internet, performs a lookup of a corresponding servicing carrier liked to the phone number to retrieve the particular routing syntax, and forwards the particular routing syntax to the hardware device via the Internet. The second server device receives the MMS message, the phone number, and the particular routing syntax from the hardware device via the Internet, verifies that the message is the MMS message from authorized users of the hardware device, determines which mobile device to forward the MMS message to, converts the phone number and the particular routing syntax into a text email address, forward the MMS message to the appropriate mobile device using the text email address via the Internet, and maintain account information for debiting users of the hardware device.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a system 100 for sending MMS messages, in accordance with one embodiment of the present invention.

FIG. 2 illustrates a method 200 for sending MMS messages, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

It is an object of this invention to provide a system wherein a user can send a MMS message using a hardware device, and the recipient can receive the message on a mobile device. Disclosed herein are a system for and a method of sending MMS messages. In embodiments, a MMS message may be a short message service (“SMS”) message, an enhanced messaging service (“EMS”) message, a multimedia messaging service (“MMS”), or any other mobile device message as known to those with skill in the art.

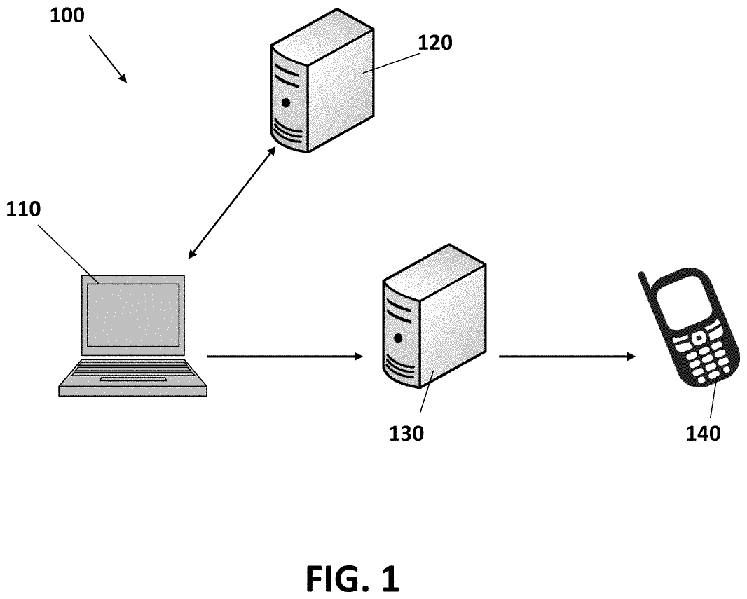

FIG. 1 illustrates a system 100 for sending MMS messages, in accordance with one embodiment of the present invention. Referring to FIG. 1, the system includes a hardware device 110, a first server 120, and a second server 130. The hardware device 110 connected to the Internet being configured to receive and forward a MMS message, a phone number, and a particular routing syntax linked to the phone number via the Internet. For example, the hardware device 110 may be a personal computer (laptop or desktop), a mobile device, a cellular phone device, a wireless email device, a terminal device and the like. The Internet may be a wired or wireless network such as a LAN, WLAN, computer network, the Internet, a cellular network, a digital data wireless network and the like. In order to receive the information as described above, the hardware device 110 may executes an application to receive the information from a user, such as a browser application. The hardware device 110 may further comprises a user account creator unit (implemented using a plurality of lines of computer code in one embodiment) that guides the user through a user sign up process in which the user provides information to set up the account including a mobile phone number.

The first server device 120 connected to the Internet being configured to receive the phone number from the hardware device 110 via the Internet, perform a lookup of a corresponding servicing carrier to retrieve the particular routing syntax linked to the phone number and forward the particular routing syntax to the hardware device 110 via the Internet.

The first server device 120 may be a computer that is set up on the Internet network for worldwide access. The first server 120 is programmed to complete a variety of tasks. These tasks include performing a look up a corresponding servicing carrier linked to a phone number to retrieve a particular routing syntax and forwarding the particular routing syntax to the hardware device 110 via the Internet.

The particular routing syntax may comprise a special e-mail address combining a recipient's phone number and a special domain name, which is typically carrier-specific. Email and web-based gateways to the MMS system are common in the U.S. For sending from external sources to mobile devices, most carriers allow a MMS message to be sent to the receiver's phone number using a special e-mail address combining the recipient's public phone number and a special domain name, which is typically carrier-specific. MMS messaging (i.e., between different carrier networks) from a hardware device to a mobile device requires input of a complete e-mail address. In particular, for a user of a hardware device to send a MMS message to a user of a mobile device, the user of the hardware device must know and input a full e-mail address of the destination device such as the exact format address syntax of a phone number on the recipient's network (e.g., “@mobile.att.net”). Exemplary full e-mail addresses typically comprise a phone number, the “@” sign, and then a unique domain name used specifically for MMS messaging. An exemplary full e-mail address is 4105551234@mobile.myportal.xyzwireless.net.

The first server device 120 may further comprise a web server (implemented using a plurality of lines of computer code in one embodiment as a software based web server) that establishes and maintains connections with the hardware device 110 over the Internet using various known protocols such as HTTP or SHTTP and serves web pages to the hardware device 110.

The second server device 130 connected to the Internet being configured to receive the MMS message, the phone number, and the particular routing syntax from the hardware device 110 via the Internet, verify that the message is the MMS message from authorized users of the hardware device 110, determine which mobile device to forward the MMS message to using the phone number and the particular routing syntax, convert the phone number and the particular routing syntax into a text email address to allow the second server device 130 to forward the MMS message, forward the MMS message to the appropriate mobile device 140 linked to the phone number and the particular routing syntax using the text email address via the Internet, and maintain account information for debiting users of the hardware device 110.

The second server device 130 may include a converter unit that executes a plurality of lines of computer code to convert a phone number and a particular routing syntax into an email address to send a SMS, an EMS or a MMS message to a mobile device 140. For example, the second server device 130 may convert a mobile phone number of 212-000-0000 on the Verizon carrier system into 2120000000@vztext.com in which the carrier's source domain name is part of the delivery address to send a text or MMS message to a mobile device 140 on the network of the carrier.

One method for debiting users of the current invention is the use of a unique identification code. Each user has its unique identification code assigned to it, and that code or personal identification number (PIN) is programmed into the second server device 130. When a user desiring to send a MMS message, connects to the hardware device 110 in his or her network, he or she sends the identification codes assigned to him or her as part of the MMS message. After ensuring that the intended recipient has received the message, the second server device 130 deducts the cost for sending MMS message.

The second server device 130 may further comprise a user data base (implemented using a plurality of lines of computer code in one embodiment) that stores the various data/information associated with each user of the system including the cell phone number, the messages, and the converted email address that is used for the messages.

The system disclosed herein includes a number of algorithms that are programmed into various physical components of the system through the user of software, hardware, or firmware. These programs enable the various physical components of the system to send, receive, and forward MMS messages.

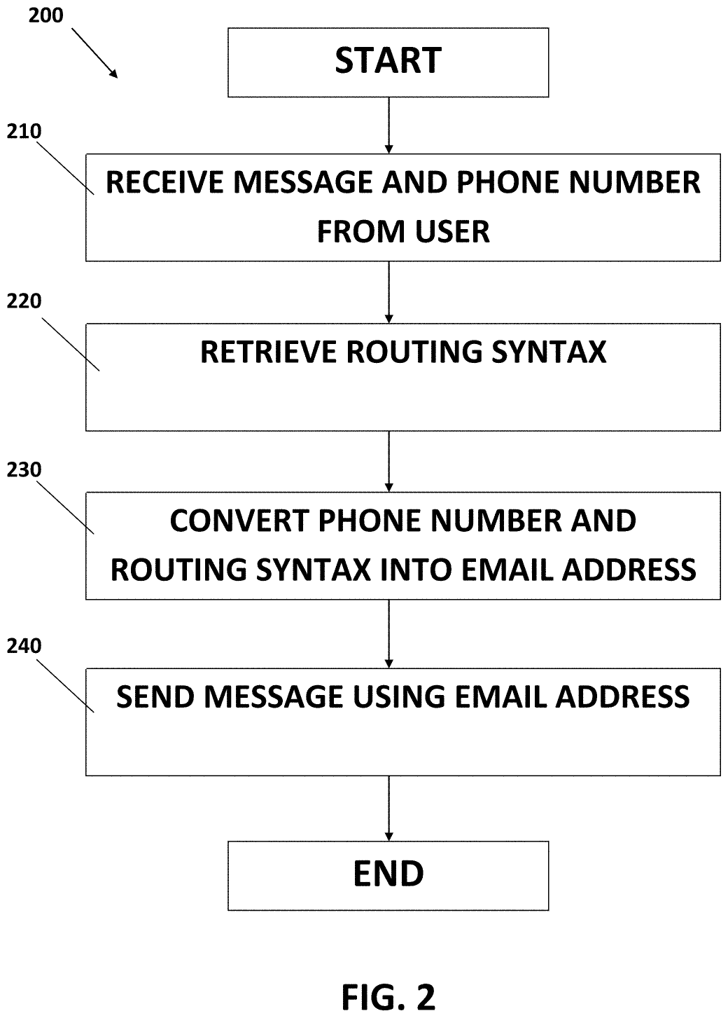

FIG. 2 illustrates a method 200 for sending MMS messages, in accordance with one embodiment of the present invention. Referring to FIG. 2, the hardware device of the system shown in FIG. 1 receives a MMS message and a phone number 210 from a user of the hardware. The hardware device then forwards the phone number to the first server device shown in FIG. 1 via the Internet. The first server device retrieves a particular routing syntax 220 linked to the phone number by performing a lookup of a corresponding servicing carrier linked to the phone number. The first server device then forwards the particular routing syntax to the hardware device via the Internet. The second server device of the system shown in FIG. 1 receives the MMS message, the phone number, and the particular routing syntax from the hardware device via the Internet, verifies that the MMS message is a MMS message from authorized users of the hardware device, determines which mobile device to forward the MMS message to, and converts the phone number and the particular routing syntax number into a text email address 230 to allow the second server device to send the MMS message. The second server device then forwards the MMS message to the appropriate mobile device 240 linked to the phone number and the particular routing syntax using the text email address via the Internet.

The system and method disclosed herein enable users in the United States to send a mobile device MMS messages using a hardware device without having to look-up the identity of the recipient's carrier and email address linked to the mobile device.

While the present invention has been related in terms of the foregoing embodiments, those skilled in the art will recognize that the invention is not limited to the embodiments described. The present invention can be practiced with modification and alternation within the spirit and scope of the appended claims. Thus, the description is to be regarded as illustrative instead of restrictive on the present invention.

What is claimed is:

1. A system for sending MMS messages, comprising:
a hardware device to receive and forward a MMS message, a phone number, and a particular routing syntax linked to the phone number via the Internet;
a first server to receive the phone number from the hardware device via the Internet, perform a lookup of a corresponding servicing carrier linked to the phone number to retrieve the particular routing syntax and forward the particular routing syntax to the hardware device via the Internet; and
a second server device to receive the MMS message, the phone number, and the particular routing syntax from the hardware device via the Internet, verify that the MMS message is a MMS message from authorized users of the hardware device, determine which mobile device to forward the MMS message to, convert the phone number and the particular routing syntax into a text email address, forward the MMS message to the appropriate mobile device using the text email address via the Internet, and maintain account information for debiting users of the hardware device.

2. The system for sending MMS messages according to claim 1, wherein the MMS message is one of a SMS message, an EMS message, and a MMS message.

3. The system for sending MMS messages according to claim 1, wherein the hardware device further comprises one of a personal computer, a mobile device, a wireless email device, a cellular phone device and terminal device.

4. The system for sending MMS messages according to claim 1, wherein the hardware device further comprises a user account creator unit.

5. The system for sending MMS messages according to claim 1, wherein the first server device further comprises one or more server computers.

6. The system for sending MMS messages according to claim 1, wherein the first server device further comprises a web server that interacts with the hardware device.

7. The system for sending MMS messages according to claim 1, wherein the second server device further comprises a user database.

8. A system for sending MMS messages, comprising:
a hardware device to receive and forward a MMS message, a phone number, and a particular routing syntax linked to the phone number via the Internet;
a first server to receive the phone number from the hardware device via the Internet, perform a lookup of a corresponding servicing carrier linked to the phone number to retrieve the particular routing syntax and forward the particular routing syntax to the hardware device via the Internet; and
a second server device to receive the MMS message, the phone number, and the particular routing syntax from the hardware device via the Internet, verify that the MMS message is a MMS message from authorized users of the hardware device, determine which mobile device to forward the MMS message to, forward the MMS message to the appropriate mobile device linked to the phone number and the particular routing syntax via the Internet, and maintain account information for debiting users of the hardware device.

9. The system for sending MMS messages according to claim 8, wherein the MMS message is one of a SMS message, an EMS message, and a MMS message.

10. The system for sending MMS messages according to claim 8, wherein the hardware device further comprises one of a personal computer, a mobile device, a wireless email device, a cellular phone device and terminal device.

11. The system for sending MMS messages according to claim 8, wherein the hardware device further comprises a user account creator unit.

12. The system for sending MMS messages according to claim 8, wherein the first server device further comprises one or more server computers.

13. The system for sending MMS messages according to claim 8, wherein the first server device further comprise a web server that interacts with the hardware device.

14. The system for sending MMS messages according to claim 8, wherein the second server device further comprises one or more server computers.

15. The system for sending MMS messages according to claim 8, wherein the second server device further comprises a user database.

16. The system for sending MMS messages according to claim 8, wherein the second server device further comprises a converter unit that converts the phone number and the particular syntax number into a text email address.

17. A method for sending MMS messages, comprising:
Receiving a request to send a MMS message with a phone number on a hardware device that is configured to receive and forward the MMS message and the phone number and a particular routing syntax linked to the phone number via the Internet;
Forwarding the phone number to a first server device via the Internet, that is configured to receive the phone number from the hardware device via the Internet to perform a lookup of a corresponding servicing carrier linked to the phone number to retrieve the particular routing syntax;
Forwarding the particular routing syntax to the hardware device from the first server device via the Internet;
Forwarding the MMS message, the phone number, and the particular routing syntax via the Internet from the hardware device to a second server device, that is configured to receive the MMS message, the phone number, and the particular routing syntax via the Internet, verify that the MMS message is a MMS message from authorized users of the hardware device, and determine which mobile device to forward the MMS message to; and
Forwarding the MMS message from the second server device to the appropriate mobile device linked to the phone number and the particular routing syntax via the Internet.

18. The method for sending MMS messages according to claim 17, further comprising creating a user account.

19. The method for sending MMS messages according to claim 17, further comprising converting the phone number and the particular routing syntax number into a text email address.

20. The method for sending MMS messages according to claim 17, further comprising debiting the account of the appropriate user after the MMS message is successfully forwarded.
